(19) United States
(12) Patent Application Publication
(10) Pub. No.: US 2003/0105753 A1
(43) Pub. Date: Jun. 5, 2003

(54) Expert system for dyeing cotton fabrics with reactive dyes

(76) Inventors: Judson Lee, San Chong City (TW); Jui-Ju Lin, Taidong City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/993,471

(22) Filed: Nov. 27, 2001

(51) Int. Cl. G06F 7/00

(52) U.S. Cl. 707/4

(57) ABSTRACT

AN expert system for dyeing cotton fabrics with reactive dyes that integrates the dyeing expertise, practical experiences and data processing technologies and has the functions of query, analysis, recommendation, inference, record, education and training. The system is applicable for the dyeing mills dyeing various cotton fabrics and provides the quantified compatibility index of any reactive dye combination, recommends the optimal recipe combination based on the change of dyeing liquor ratio and design dyeing process online based on the structure specifications of fabrics and the parameters of dyeing machines.

### BACKGROUND OF THE INVENTION

The present invention relates to an expert system for dyeing cotton fabrics with reactive dyes that have industrial utility and can solve complicated production problems by integrating information technology and professional dyeing technologies.

The conventional cotton fabric dyeing technologies have currently developed to its mature stage. However, due to the lack of professional technicians, it is difficult for manufacturers to success related experiences and technologies, and this fact causes the loss of manufacturing technical resources.

The present invention integrates the experiences in this dyeing technology and the electronic data process technology, and is used as a tool for dyeing mills to create their key technologies and maintain their technical resources. The present invention is also used as a comprehensive technical reference for professionals.

### SUMMARY OF THE INVENTION

An objective of the present invention is to provide an expert system for dyeing cotton fabrics with reactive dyes which has an open database as its data structure to which new data can be added at any time. Based on the dyeing exhaustion curve, the present invention calculates the compatibility index of dye combinations and integrates the dye features, fabric specifications, and parameters of dyeing machines to design virtual dyeing processes online. The present invention provides an application system that is currently not available in the dyeing industry

According to the aforementioned, the present invention has the following major features:

1. An open knowledge library design that allows the entry of various reactive dyes without the limitation to any specific dye and can meet the application demand of dyeing mills.

2. Predicting the compatibility of dye combinations and calculating their compatibility indices based on the dyeing feature parameters of individual reactive dye to understand the good and bad of the dye combination rapidly without the need to repeat tests.

3. Recommending accurately the most appropriate salt (sodium sulfate) and alkali (sodium carbonate) volume according to the dye concentration. Comparing with the traditional approach, 15.5% of the salt volume and 12% of the alkali volume can be saved by using the present invention. The present invention can adjust the salt volume or dye concentration based on the change of the liquor ratio to facilitate the reproducibility of bulk dyeing.

4. Creating key technologies for dyeing mills based on the type of fabrics, machines and the customized dyeing processes of the dye combination design used by the dyeing mills.

The development framework and the system contents of the present invention is described in detail with the following drawings:

### BRIEF DESCRIPTION OF THE DRAWINGS

FIG. 1 is the dyeing feature diagram of the reactive dye;

FIG. 2 is the dyeing exhaust curve diagram of the recipe in example 1;

FIG. 3 is the dyeing exhaust curve diagram of the recipe in example 2;

FIG. 4 is the recommendation diagram of accurate salt volume for the expert system;

FIG. 5 is the recommendation diagram of accurate alkali volume for the expert system;

FIG. 6 is the schematic diagram of the feature parameter database of the dye;

FIG. 7 is the schematic compatibility evaluation diagram of the dye combination;

FIG. 8 is the schematic design diagram of the optimized dyeing profile;

FIG. 9 is the schematic diagram of the recipe optimization.

### DETAILED DESCRIPTION OF THE INVENTION

The present invention provides an expert system for dyeing cotton fabrics with reactive dyes which is a system that integrates the expertise of dyeing, practical experiences and electronic data process technology to provides the functions of query, analysis, recommendation, record, inference, education and training.

The expert system for dyeing cotton fabrics with reactive dyes is used for the exhaust dyeing works of the reactive dye used for 100% cotton fabrics and has:

a user interface used for users to input data and display the computing results of the invented expert system;

a database used to store the dyeing feature parameters of the reactive dye;

a knowledge library containing the dyeing process parameter groups of the reactive dye, dyeing process design criteria and algorithm; and

an inference engine containing a query serial and a computing procedure used to bind the data input by users with the database and the knowledge library for operation.

The major tasks of the expert system for dyeing cotton fabrics with reactive dyes includes:

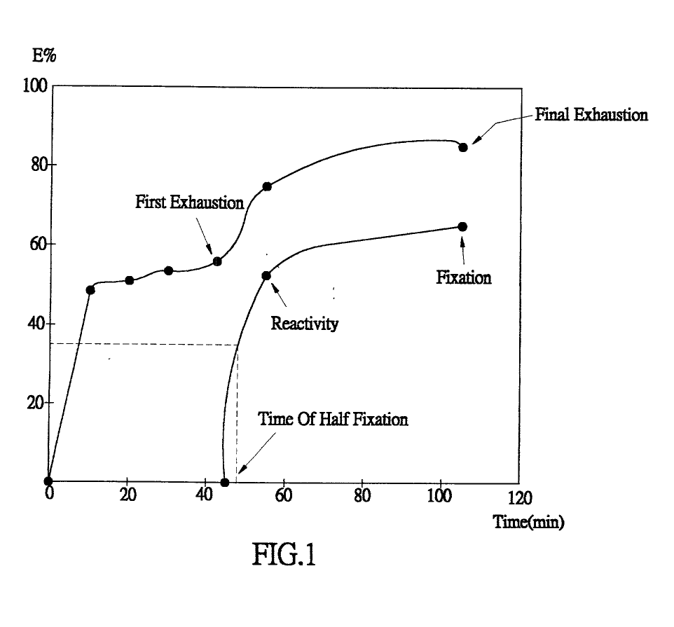

1. Calculate the dyeing feature parameters of the reactive dye based on the phase dyeing test results, measured absorbency (ABS) of residual dyeing solution and K/S of close surface, including first exhaustion, final exhaustion, reactivity, fixation and T₅₀ (time of half fixation) as shown in FIG. 1, so that users can fully understand the coloration behavior of the dye and use it as the basis of the dye combination and dyeing process design.

2. Infer the compatibility of the dye combinations based on the dyeing feature parameters of individual dye and give a quantified index.

EXAMPLE 1
Liquor Ratio 1:10

| | | |
|---|---|---|
| Recipe | 0.5% | Blue H-ERD |
| | 0.5% | Yellow H-E6G |
| | 0.5% | Red H-E7B |
| | 60 g/l | Na₂SO₄ |
| | 15 g/l | Na₂CO₃ |

| | |
|---|---|
| Dyeing process | 80° C. × 60 min. |
| Washing | 100° C. × 20 min. |

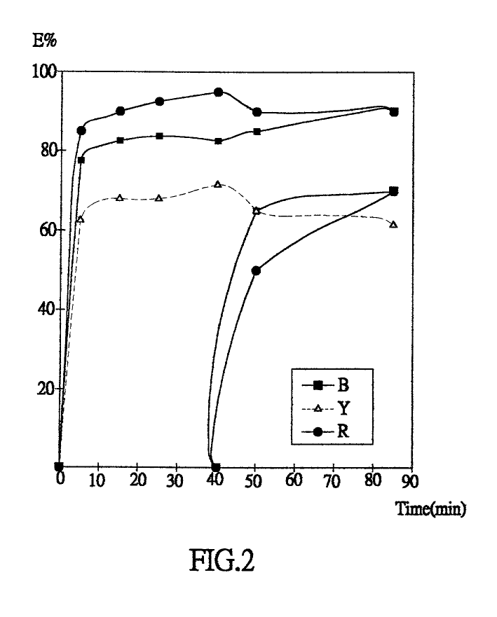

The dyeing feature parameters of the dye in the recipe is shown in Table 1 below and the dyeing exhaust curve is shown in FIG. 2. The compatibility index 75.6% is inferred by using the inference mechanism.

EXAMPLE 2
Liquor ratio 1:10

| | | |
|---|---|---|
| Recipe | 1.0% | Blue BRF |
| | 1.0% | Yellow 3GF |
| | 45 g/l | Na₂SO₄ |
| | 16 g/l | Na₂CO₃ |

| | |
|---|---|
| Dyeing process | 60° C. × 60 min. |
| Washing | 100° C. × 20 min. |

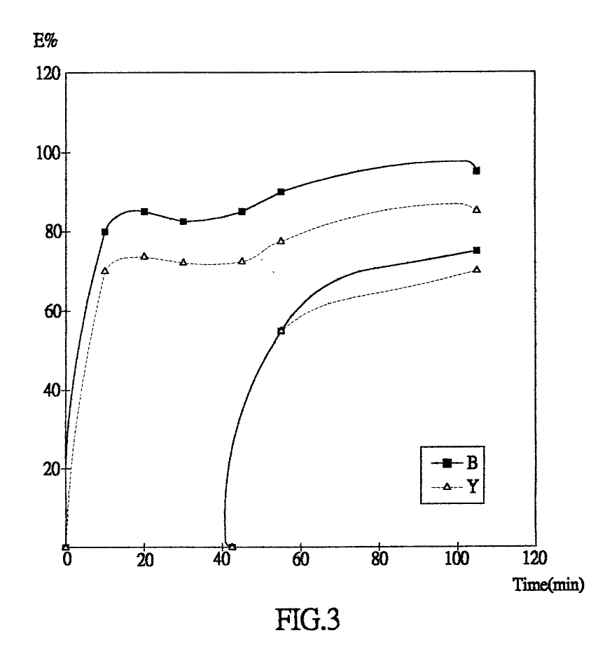

The dyeing feature parameters of the dye in the recipe is shown in Table 2 below and the dyeing exhaust curve is shown in FIG. 3. The compatibility 97.1% is inferred by using the inference mechanism.

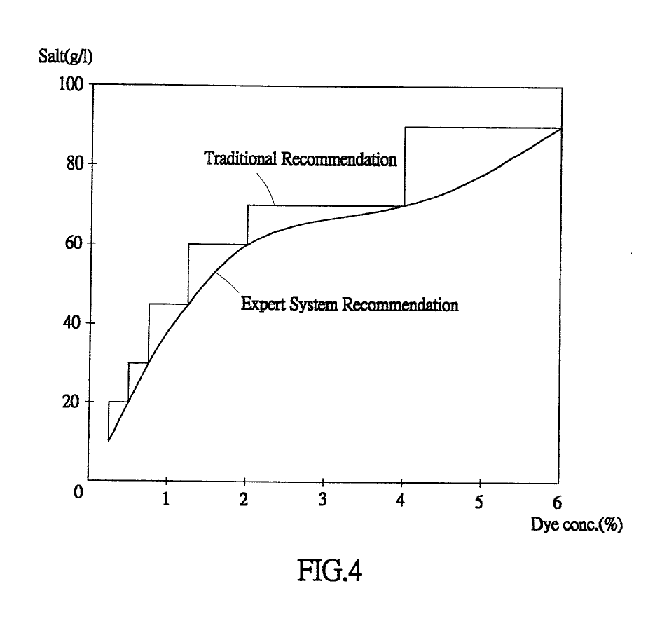

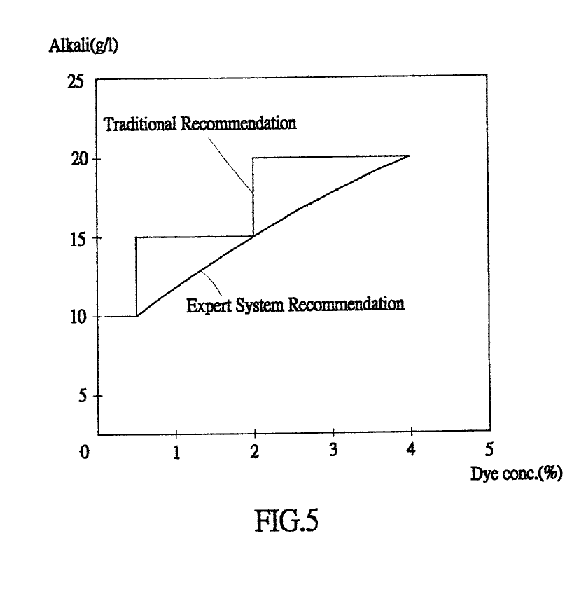

3. Recommend accurately the most appropriate salt and alkali volume according to the dye concentration. Comparing with the traditional approach, 15.5% of the salt volume and 12% of the alkali volume can be saved by using the present invention as shown in FIG. 4 and 5.

4. When the dyeing liquor ratio changes, the salt volume or the dye concentration can be adjusted to optimize the recipe and facilitate the dyeing reproducibility.

### EXAMPLE 1

### Adjust the Salt Volume when the Dyeing Liquor Ratio Changes

Based on the liquor ratio 1:10, this approach is recommended when the liquor ratio lies between 6-20 as shown in Table 3.

### EXAMPLE 2

### Fix the Salt Volume and Adjust the Dye Concentration when the Dyeing Liquor Ratio Changes

Based on the liquor ratio 1:10, this approach is recommended when the liquor ratio is greater than 30 as shown in Table 4.

5. Verify the professional technologies and practice experiences of dyeing professionals with theories and tests to make them logical and rationalized, create the inference mechanism for dyeing cotton fabric with reactive dyes and recommend the optimal dyeing conditions according to the demand of users.

### DETAILED DESCRIPTION OF THE PREFERRED EMBODIMENT

To make the Examination Committee further understand the concrete technical contents and the deeper spirit of the present invention, several applications and embodiments is described in details as follows:

Embodiment 1: Dye Feature Parameter Database

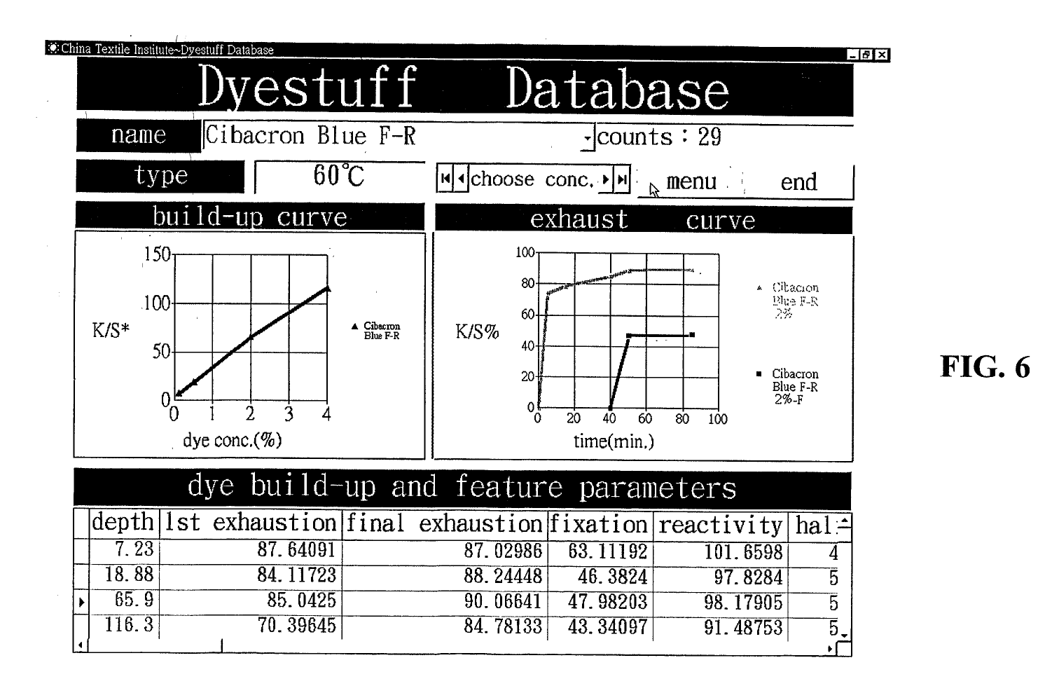

As shown in FIG. 6, users can select any one of the dyes in the database by dye names to understand the dye feature parameters, build-up and dyeing exhaust curve of this dye. When different dyes are selected, the system can compute and display the parameters, graphics and curves in a real-time manner to provide dyeing professionals with complete technical dyeing data rapidly. Embodiment 2: Compatibility Evaluation of Dye Combinations

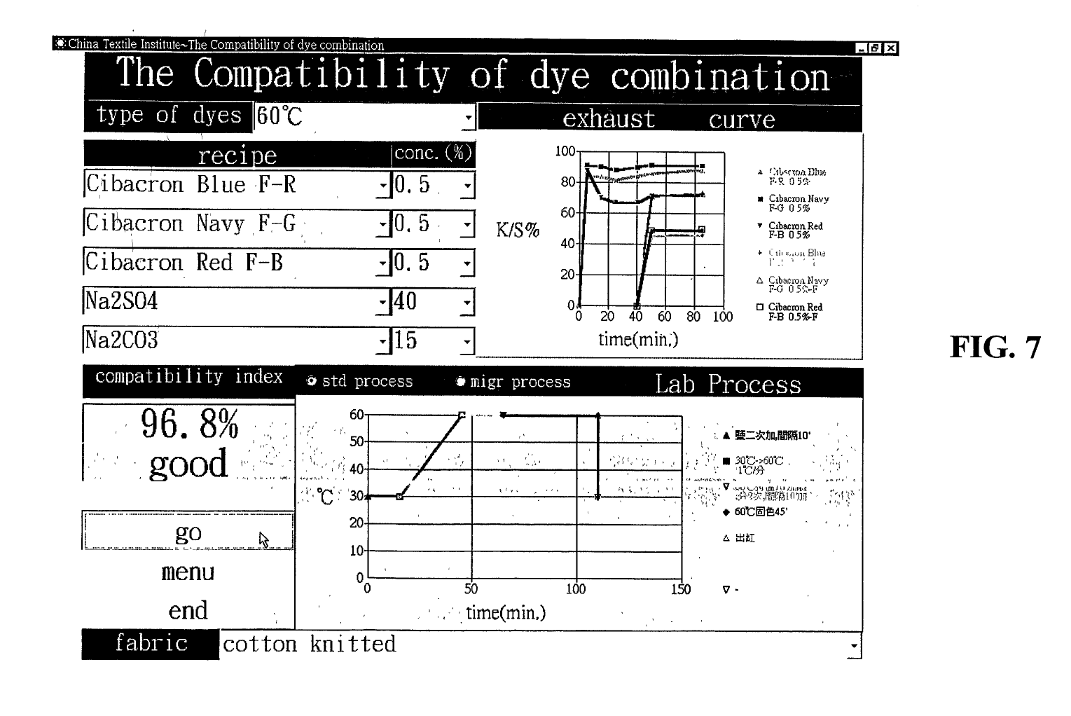

The present invention is applicable for the compatibility evaluation of any dye combination in the database and can calculate its compatibility index. All the dye combinations within the concentration in the database can be computed in a real-time manner as shown in FIG. 7. Users can gain real-time results and understand the good and bad of the dye combinations without the need to test one by one.

Embodiment 3: Optimization of the Dyeing Process

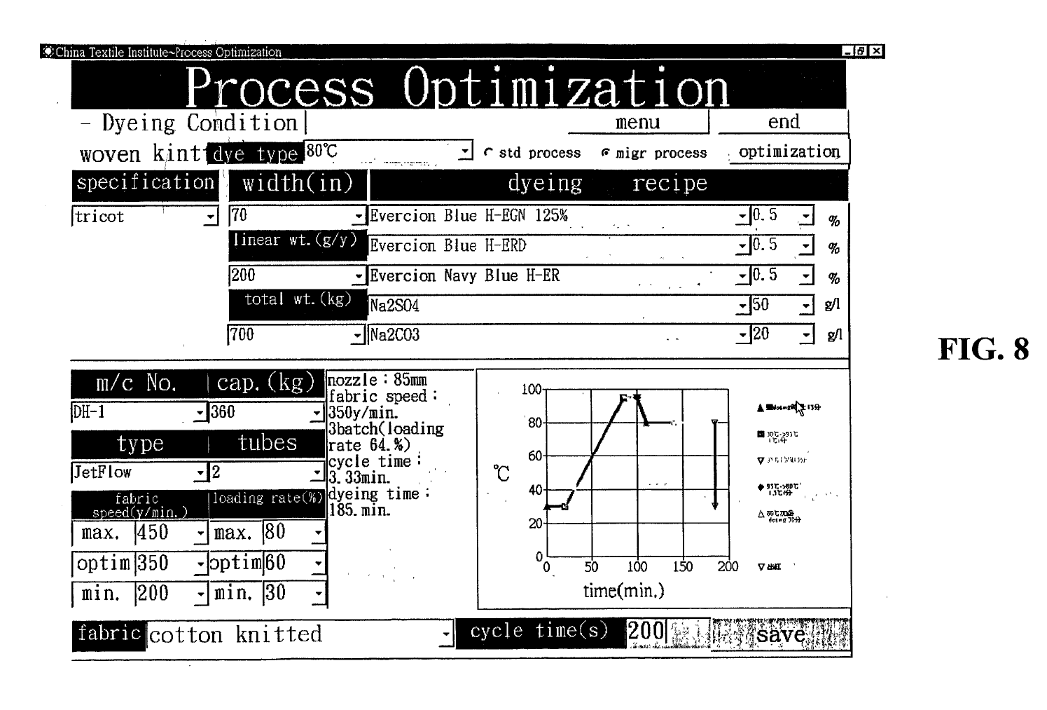

As shown in FIG. 8, the present invention can integrate the existing operation parameters of dyeing machines, the structure specifications of fabrics and dye combinations of the factory to provide a customized dyeing process design applicable for the creation and maintenance of the key dyeing technologies in dyeing mills.

Embodiment 4: Optimization of Recipe Combinations

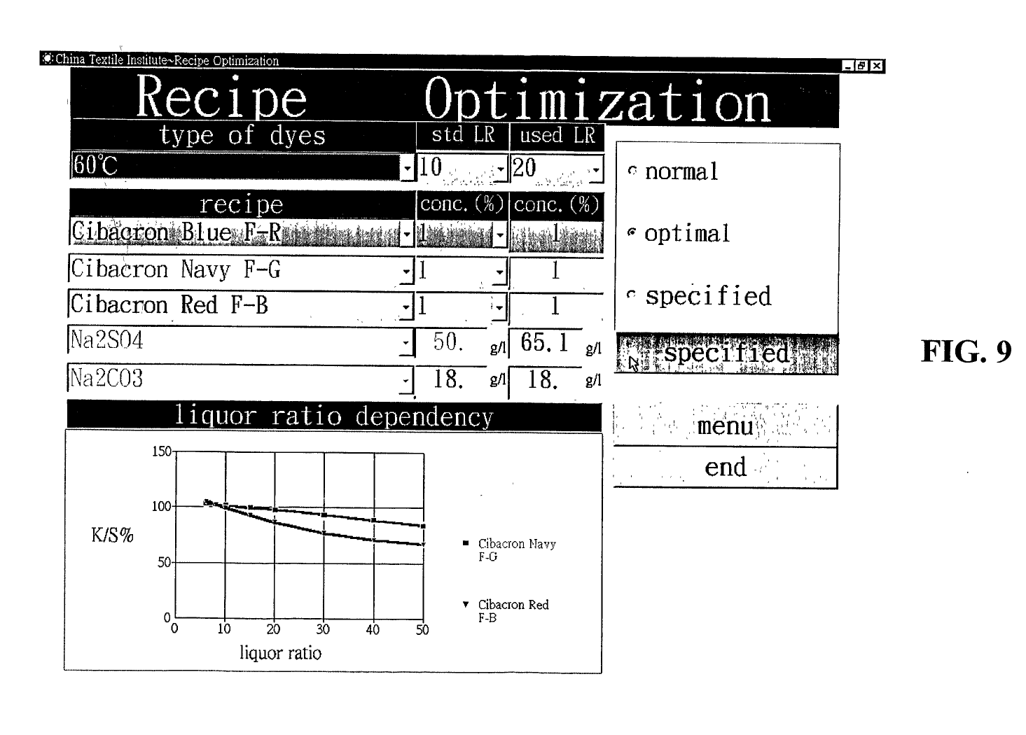

When dyeing with reactive dye, the reproducibility of the dye is greatly affected by the dyeing liquor ratio, a frequently occurred problem in the production of dyeing mills. As shown in FIG. 9, the present invention can recommend the optimal recipe combination and adjust the salt volume or dye concentration based on the dependency of the dyes on the liquor ratio when it changes to reach the goal of good reproducibility.

As shown in the drawings and tables, the invented expert system for dyeing cotton fabrics with reactive dyes can recommend the optimal dyeing process based on the exhaust dyeing works and recipe of the fabric reactive dyes. The present invention is applicable especially for dyeing 100% cotton fabrics to provide the functions of query, analysis, recommendation, record, inference, education and training. In the practical production, the present invention can provide the quantified compatibility index of any reactive dye combinations to evaluate the good or bad of the specific dye combination. The present invention can also provide optimal dyeing process designs based on the structure specifications of the fabrics and the operation parameters of dyeing machines to lower down the cost significantly.

Based on the aforementioned, the whole technical contents and thought of the present invention are unprecedented. The expert system for dyeing cotton fabrics with reactive dyes can reach the expected goal in the aspect of facilitating technology upgrade of the industry, shortening the time period needed for R&D, improving the quality of dyeing and promoting the succession of key dyeing technologies, and, therefore, is much useful for the industry and meets the requirements of the application for the patent. It is requested that the Examination Committee can examine the application in details and grant the patent as soon as possible.

TABLE 1
The dyeing feature parameters of the recipe in example 1

| | Dye | | |
|---|---|---|---|
| | Blue | Yellow | Red |
| | H-ERD | H-E6G | H-E7B |
| Parameter | | | |
| First exhaustion (E₁) | 81.5 | 74.6 | 95.7 |
| Final exhaustion (E₂) | 90.6 | 62.4 | 89.7 |
| Reactivity (R) | 82.8 | 84.0 | 67.4 |
| Fixation (F) | 79.5 | 49.3 | 78.3 |
| T₅₀ | 6.0 | 6.0 | 7.4 |

| | |
|---|---|
| Compatibility index (C) | 75.6% |

TABLE 2
The dyeing feature parameters of the recipe in example 2

| | Dye | |
|---|---|---|
| | Blue BRF | Yellow 3GF |
| Parameter | | |
| First exhaustion (E₁) | 87.4 | 76.1 |
| Final exhaustion (E₂) | 95.5 | 87.1 |
| Reactivity (R) | 73.7 | 85.1 |
| Fixation (F) | 77.8 | 69.1 |
| T₅₀ | 6.0 | 5.9 |

| | |
|---|---|
| Compatibility index (C) | 97.1% |

TABLE 3
Salt volume adjusting test result when the dyeing liquor ratio changes

| | Dye | | | | | |
|---|---|---|---|---|---|---|
| | Blue H-ERD | | | Yellow H-E4R | | |
| Liquor ratio | 10 | 20 | 20 | 10 | 20 | 20 |
| Concentration (%) | 2 | 2 | 2 | 2 | 2 | 2 |
| Salt (g/l) | Standard | Unadjusted | Adjusted | Standard | Unadjusted | Adjusted |
| | 60 | 60 | 78 | 60 | 60 | 78 |
| Alkali (g/l) | 15 | 15 | 15 | 15 | 15 | 15 |
| K/S | 6.51 | 5.94 | 6.70 | 9.32 | 8.76 | 9.26 |
| d K/S % | — | −8.8% | −2.9% | — | −6.0% | 0.6% |
| dE_{(cmc)} | — | 1.18 | 0.16 | — | 0.77 | 0.10 |

TABLE 4
Test result of fixed salt volume and adjusted dye concentration
when the dyeing liquor ratio changes

| | Dye | | | | |
|---|---|---|---|---|---|
| | Navy Blue H-ER | | | | |
| liquor ratio | 10 | 30 | 30 | 40 | 40 |
| Concentration | Standard | Unadjusted | Adjusted | Unadjusted | Adjusted |
| (%) | 2 | 2 | 2.22 | 2 | 2.33 |
| Salt (g/l) | 60 | 60 | 60 | 60 | 60 |
| Alkali (g/l) | 15 | 15 | 15 | 15 | 15 |
| K/S | 11.50 | 10.57 | 11.80 | 10.02 | 11.84 |
| d K/S % | — | −8.1% | −2.6% | −12.9% | 3.0% |
| dE_{(cmc)} | — | 1.46 | 0.38 | 2.19 | 0.46 |

What is claimed is:

1. An expert system for dyeing cotton fabrics with reactive dyes used for the exhaust dyeing works of the reactive dye used for 100% cotton fabrics, comprising:
a user interface used for users to input data and display the computing results of the expert system;
a database used to store the dyeing feature parameters of the reactive dye;
a knowledge library containing dyeing process parameter groups of reactive dye, dyeing process design criteria and algorithm; and
an inference engine containing a query serial and a computing procedure used to bind data input by users with the database and the knowledge library for operation.

2. The expert system for dyeing cotton fabrics with reactive dyes as claimed in claim 1, wherein the data input is the K/S and absorbency of the reactive dye.

3. The expert system for dyeing cotton fabrics with reactive dyes as claimed in claim 1, wherein the system computing results include: compatibility indices, recommended salt volume, recommended alkali volume, dyeing processes and costs.

4. The expert system for dyeing cotton fabrics with reactive dyes as claimed in claim 1, wherein dyeing feature parameters include first exhaustion, final exhaustion, reactivity, fixation and T₅₀.

5. The expert system for dyeing cotton fabrics with reactive dyes as claimed in claim 1, wherein the parameter groups of dyeing processes include: cotton fabrics specification, operation parameters of dyeing machines, dyeing liquor ratio and dye recipe.

6. The expert system for dyeing cotton fabrics with reactive dyes as claimed in claim 1, wherein the criteria for the dyeing process design are the dyeing criteria for 60° C. reactive dyes and the dyeing criteria for 80° C. reactive dyes.

7. The expert system for dyeing cotton fabrics with reactive dyes as claimed in claim 1, wherein the algorithms include the compatibility index algorithm, salt volume algorithm and alkali volume algorithm.

8. The expert system for dyeing cotton fabrics with reactive dyes as claimed in claim 1, wherein there is a query serial and a computing procedure as logical inference approaches; the expert system will compare the parameters in the database with the data input and queries requested by users automatically and display the results computed based on the computing criteria in the knowledge library on the user interface.
